(19) United States
(12) Patent Application Publication
(10) Pub. No.: US 2005/0214428 A1
(43) Pub. Date: Sep. 29, 2005

(54) Non-steeped corn blend and article of commerce

(76) Inventors: Yonas Gizaw, Cincinnati, OH (US); Carolyn Anne O'Connell, West Chester, OH (US); David Arthur Lanner, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/806,555

(22) Filed: Mar. 23, 2004

(51) Int. Cl. A21D 10/00

(52) U.S. Cl. 426/549

(57) ABSTRACT

A non-steeped corn blend that can be used as a substitute for corn masa in food applications. The non-steeped corn blend comprises: (1) non-steeped non-gelatinized corn material, (2) non-steeped pre-gelatinized corn material, and (3) pH increasing agent. The non-steeped corn blend can be used to make masa-type dough and food products. In another aspect, the present invention provides an article of commerce that comprises directions for making a mesa-type dough or food product.

### TECHNICAL FIELD

The present invention relates to a non-steeped corn blend that can be used as a substitute for corn masa in food applications. The invention also relates to an article of commerce.

### BACKGROUND OF THE INVENTION

Tortilla chips are particularly popular consumer snack products. Tortilla chips are traditionally made from whole kernel corn that has been cooked in a hot lime solution for about 5 minutes (300 seconds) to about 50 minutes (3,000 seconds), then steeped overnight. The cooking-steeping process softens the outer hull and partially gelatinizes the starch in the endosperm of the corn. This cooked-steeped corn, called “nixtamal,” is then washed to remove the outer hull and ground to form a plastic dough, known as “masa,” that contains about 50% moisture. The freshly-ground masa is sheeted, cut into snack pieces, and baked for about 15 to about 30 seconds at a temperature of from about 575° F. to about 600° F. (302° C. to 316° C.) to reduce the moisture content to from about 20% to about 35%. The baked snack pieces are then fried in hot oil to form tortilla chips having a moisture content typically less than about 3%. See, e.g., U.S. Pat. No. 2,905,559 to Anderson et al., U.S. Pat. No. 3,690,895 to Amadon et al., and Corn: Chemistry and Technology, American Association of Cereal Chemists, Stanley A. Watson, et. al., Ed., pp. 410-420 (1987).

Tortilla chips can also be made from dried masa flour. In typical processes for making such dried masa flour, such as those described in U.S. Pat. No. 2,704,257 to Diez De Sollano et al., and U.S. Pat. No. 3,369,908 to Gonzales et al., the lime-treated corn is ground and dehydrated to a stable form. The dried masa flour is later rehydrated with water to form a masa dough that is then used to produce tortilla chips in the traditional manner.

Masa is also used to make many other foods such as tortillas, taco shells, and tamales. However, despite the popularity of such foods, they are not readily available in many parts of the world due to the unavailability of corn masa. The typical commercial production of corn masa produces large amounts of waste caustic material from the liming process. In many regions of the world, it is extremely difficult to find cost-effective means of disposal for the waste caustic generated in the production of corn masa. Because waste disposal is cost-prohibitive, corn masa is not commercially manufactured and products made from corn masa are thus not readily available.

Accordingly, it would be desirable to provide a corn-based product that can be used as a whole or partial substitute for corn masa.

This and other objects of the invention will become apparent from the following disclosure and claims as set forth below.

### SUMMARY OF THE INVENTION

The present invention provides a non-steeped corn blend that can be used as a whole or partial substitute for corn masa. The non-steeped corn blend comprises: (1) non-steeped non-gelatinized corn material, (2) non-steeped pre-gelatinized corn material, and (3) pH increasing agent.

In another aspect, the present invention provides a masa-type dough. In one embodiment, the masa-type dough comprises: (1) a non-steeped corn blend, and (2) water.

In another aspect, the invention provides food products made from a non-steeped corn blend or masa-type dough.

The invention also provides a method for making a food product. In one embodiment, the method comprises: (1) combining a non-steeped corn blend with water to form a masa-type dough, (2) forming a food piece from said masa-type dough, and (3) cooking said food piece to form a food product.

In yet another aspect, the present invention provides an article of commerce comprising: (1) a non-steeped corn blend, (2) optionally, a container for containing the non-steeped corn blend, and (3) a message associated with the non-steeped corn blend. In another embodiment, the article of commerce comprises: (1) a non-steeped corn blend material selected from the group consisting of non-steeped non-gelatinized corn material, non-steeped pre-gelatinized corn material, a pH increasing agent, and mixtures thereof, and (2) a message associated with the non-steeped corn blend material. In one embodiment, the message comprises instructions that direct the consumer to use the article of commerce to make a masa-type dough or food product.

All documents cited herein are, in relevant part, incorporated herein by reference; the citation of any document is not to be construed as an admission that it is prior art with respect to the present invention.

All percentages herein are by weight unless stated otherwise.

### DETAILED DESCRIPTION OF THE INVENTION

A. Non-Steeped Corn Blend

In one aspect, the present invention provides a non-steeped corn blend comprising: (1) non-steeped non-gelatinized corn material, (2) non-steeped pre-gelatinized corn material, and (3) pH increasing agent. The non-steeped corn blend can also optionally include optional ingredients. The non-steeped corn blend can be used to make food products that have traditionally been made using corn masa. (As used herein, the term “corn masa” is broad enough to include any corn masa product, including corn masa flour.)

As used herein, “steeped” means soaked in lime water at elevated temperature.

As used herein, “non-steeped” means that a material has not been subjected to steeping.

As used herein, “blend” or “the blend” is synonymous with “non-steeped corn blend.”

As used herein, “pre-gelatinized” is synonymous with “pre-gelled.” The term “pre-gelatinized” or “pre-gelled” includes any degree of gelatinization, including partial or complete starch gelatinization.

Preferably, the non-steeped corn blend comprises from about 10% to about 90% non-steeped non-gelatinized corn material, more preferably from about 40% to about 80%, and most preferably from about 75% to about 90%. Preferably, the non-steeped corn blend comprises from about 10% to about 90% non-steeped pre-gelatinized corn material, more preferably from about 20% to about 60%, and most preferably from about 10% to about 25% non-steeped pre-gelatinized corn material.

In one embodiment, the non-steeped corn blend has a peak viscosity of from about 600 cP (centipoise) to about 2600 cP, preferably from about 800 cP to about 2400 cP; a final viscosity of from about 800 cP to about 3600 cP; and a peak time of from about 3.5 minutes (210 seconds) to about 6 minutes (360 seconds).

The components of the non-steeped corn blend can be added or combined together in any order, by any suitable means, and at any suitable stage of use as desired. For instance, one or more of the blend components can be combined with optional ingredients, then later combined together with water for use in a dough. In a particular embodiment, each component is added sequentially with water to form a dough. In this embodiment, although the non-steeped corn blend components do not come into contact with one another until after each is added to make the dough, they are nonetheless considered a non-steeped corn blend at the time they do come into contact with one another for purposes of the present invention.

In one embodiment, the non-steeped non-gelatinized corn material and the non-steeped pre-gelatinized corn material are mixed together, optionally with optional ingredients, before the pH increasing agent is added. In one embodiment, before the pH increasing agent is added, the mixture of the corn materials and optionally any optional ingredients has a peak viscosity of from about 400 cP (centipoise) to about 2500 cP, preferably from about 1600 cP to about 2000 cP; a final viscosity of from about 850 cP to about 6000 cP, preferably from about 3400 cP to about 5000 cP; and a peak time of from about 3.5 minutes (210 seconds) to about 7 minutes (420 seconds), preferably from about 4 (240 seconds) minutes to about 6 minutes (360 seconds).

1. Corn Material

Any suitable corn material can be used herein. For example, corn materials can include corn products such as, but not limited to, corn flour, corn starch, corn meal, corn cones, corn grits, or mixtures thereof. Suitable corn materials can include those, for example, described in Corn: Chemistry and Technology, American Association of Cereal Chemists, Stanley A. Watson, et. al., Ed., pp. 351-372 (1987).

Non-Steeped Non-Gelatinized Corn Material

Any suitable non-steeped non-gelatinized corn material can be used herein. For example, the non-steeped non-gelatinized corn material can include dry-milled corn products. In one embodiment, the non-steeped non-gelatinized corn material is degermed and milled flour that has not been cooked, and comprises primarily intact starch granules. Non-limiting examples of non-steeped non-gelatinized corn material include White Corn Flour WCCF™-611 (Bunge Milling, Danville, Ill., USA), Yellow Corn Flour CCF™-610 (Bunge Milling, Danville, Ill., USA), and White Corn Flour (Cargill, Inc., Wayzata, Minn., USA), and mixtures thereof.

As used herein, “non-gelatinized” means not cooked or otherwise gelatinized by any means.

Depending upon desired taste and texture attributes, different types of non-gelatinized corn materials can be combined for use as the non-steeped non-gelatinized corn material herein. As used herein, the term “non-steeped non-gelatinized corn material” includes one or a mixture of more than one type of non-steeped non-gelatinized corn material.

Preferably, the non-steeped non-gelatinized corn material has a peak viscosity of from about 2500 cP to about 4500 cP, a final viscosity of from about 3500 cP to about 7000 cP, and a peak time of from about 3 minutes (180 seconds) to about 6 minutes (360 seconds). Preferably, the non-steeped non-gelatinized corn material has a particle size distribution (PSD) such that a maximum of about 45% is retained on a U.S. 100 sieve (at least about 55% passes through).

Non-Steeped Pre-Gelatinized Corn Material

Any suitable non-steeped pre-gelatinized corn material can be used herein. As used herein, the term “pre-gelatinized” is broad enough to include any degree of gelatinization, including fully gelatinized and partially gelatinized. Gelatinization processes are well-known in the art; see, for example, Cereal Foods World, (33) 306, 1988. See also Application for Rapid Visco Analyses, November 1998, Newport Scientific Pty., Ltd., pp. 13-18.

Preferably, the partially pre-gelatinized corn material has a peak viscosity of from about 200 cP to about 400 cP, a final viscosity of from about 350 cP to about 550 cP, and a peak time of from about 3 minutes (180 seconds) to about 5 minutes (300 seconds).

In one embodiment, the non-steeped pre-gelatinized corn material is pre-gelled corn flour that has been degermed and cooked to gelatinize at least some of the starch granules.

Non-limiting examples of non-steeped pre-gelatinized corn materials include Larodex™ (ADM, Decatur, Ill., USA), and PCPF™ 400 (Bunge Milling, Danville, Ill., USA) with a particle size distribution such that from about 92% to about 100% passes through a U.S. 40 sieve.

2. pH Increasing Agent

As used herein, the term “pH increasing agent” means an agent capable of increasing the pH of the non-steeped corn materials when added thereto. The term does not include, however, agents having a pH increasing effect that are inherently present in optionally added ingredients; for instance, if masa flour is added as an optional ingredient, any residual lime that may be present as a result of the masa flour's processing is not considered to be part of the pH increasing agent herein.

Any desired, effective amount of pH increasing agent can be used herein. Preferably, the pH increasing agent is added to corn material to produce a non-steeped corn blend having a pH of from about 7 to about 10.

Any suitable pH increasing agent can be used herein. The pH increasing agent can include, but is not limited to, calcium hydroxide (“lime”), sodium hydroxide, calcium carbonate, sodium bicarbonate (baking soda), and mixtures thereof. Flavor and texture of the final food product is affected by the type and amount of pH increasing agent used, thus one can vary the pH increasing agent to customize the desired flavor and texture.

For example, in one embodiment, calcium hydroxide is used to slightly increase the peak viscosity and decrease the peak time of the non-steeped corn blend. Furthermore, the addition of calcium hydroxide can impart the characteristic flavor, color, and texture of corn masa to the doughs and food products made from the non-steeped corn blend comprising calcium hydroxide.

In addition to waste elimination, non-steeped corn blends provide additional advantages over traditional masas. For instance, because the corn materials are not steeped, the amount of pH increasing agent (e.g., lime) used for making a masa-type dough can be less than that amount required for making a masa dough, since a certain minimum amount of lime must be used for steeping. Conversely, no minimum amount of pH increasing agent is required for making the non-steeped corn blend and masa-type dough; thus, a wider range of pH increasing agent concentrations can be used, resulting in a wider range of flavor and texture options. In addition, one can easily vary the particular pH increasing agent used, also resulting in a wider range of flavor and texture options.

The pH increasing agent can be added in any suitable form. For example, it can be added directly as a powder. Alternatively, it can be added in the form of a solution or in suspension. As used herein, “added” includes bringing the pH increasing agent and the other non-steeped corn blend ingredients into contact by any means, in any order, and during any step of the making process. For example, the pH increasing agent can be poured, mixed, combined, or otherwise contacted with the other corn materials. In one embodiment, the pH increasing agent is combined with optional ingredients, then this combination is combined with corn materials and water to make a masa-type dough.

If the non-steeped corn blend will be stored or shipped before use, it can be advantageous to use a powder form of the pH increasing agent. In one embodiment, a powdered pH increasing agent is mixed with the corn materials to form a non-steeped corn blend which is packaged in bags for shipping or storage. In a particular embodiment, the particle size of the powdered pH increasing agent is similar in particle size to the corn materials, such that segregation of the non-steeped corn blend ingredients is minimized during storing or shipping.

In another embodiment, the corn materials are blended together and packaged; a package of powdered pH increasing agent is shipped with the bagged corn materials. In yet another embodiment, a package of powdered pH increasing agent is shipped with one or more bags of other ingredients used to make a non-steeped corn blend. In these embodiments, although the corn materials and pH increasing agent are physically separated for storage or shipping, they are nonetheless considered a non-steeped corn blend once they are combined for purposes of the present invention.

3. Optional Ingredients

Any other suitable ingredients can optionally be included in the blend as desired. For example, optional ingredients can be included to customize taste, texture, or other properties. Optional ingredients can include, but are not limited to, starches, colorants, protein, fiber, vitamins, minerals (e.g., micronutrients), flavor precursors, favoring agents, seasonings, and mixtures thereof.

For example, in one embodiment, the blend includes from about 0% to about 20%, preferably from about 5% to about 12%, added starch. As used herein, the term “added starch” or “starch” does not include the non-steeped non-gelatinized corn material, non-steeped pre-gelatinized corn material, or pH increasing agent. The terms “starch” and “starches” are used synonymously to mean one or a combination of more than one starch.

Starches for use herein can include any suitable type of starch, such as those disclosed in U.S. Pat. No. 6,558,730 issued May 6, 2003, to Gizaw et al. For example, starches can include, but are not limited to, raw starches, native starches, non-native starches, modified starches, pre-gelatinized starches, non-gelatinized starches, partially gelatinized starches, or mixtures thereof. Starches herein include materials comprised primarily of starch such as, but not limited to, pure starch, flours, meals, powders, or any other suitable form. Sources of starches can include, but are not limited to, tubers, roots, legumes, cereals, grains, and combinations thereof. For instance, starches can be sourced from wheat, corn, potato, rice, barley, tapioca, sago, or any other suitable source.

Further examples of added starches include waxy corn starch, oat starch, cassava starch, waxy barley starch, waxy rice starch, glutenous rice starch, sweet rice starch, amioca starch, potato starch, tapioca starch, masa corn flour, rice flour, tapioca starch, buckwheat flour, rice flour, oat flour, bean flour, barley flour, and mixtures thereof.

In one embodiment, hydroxypropyl starch is used. Another embodiment uses stabilized starch. One embodiment comprises hydrolyzed starch. In a particular embodiment, the hydrolyzed starch has a DE (dextrose equivalent) value of from about 0 to about 35.

In one embodiment, the optional ingredients comprise natural flavoring agent, artificial flavoring agent, or mixtures thereof. Such flavoring agents can include Fried Masa Flavor SN™-043638 (International Flavors and Fragrances, New York, N.Y., USA), Flav-R-Grain™ (Quali Tech, Chaska, Minn., USA), and Artificial Toasted Corn™ Type 474194 (Givaudan S. A., Geneve, Switzerland).

Although the present invention can be used as a substitute for corn masa or corn masa flour, corn masa or corn masa flour or mixtures thereof can also be used as optional ingredients when it is desired to use the non-steeped corn blend as only a partial replacement. In these embodiments, the non-steeped corn blend can comprise corn masa flour as an optional ingredient, or the masa-type dough can comprise corn masa flour, corn masa, or mixtures thereof.

B. Masa-Type Dough

A masa-type dough can be made by combining the non-steeped corn blend with water. Alternatively, a masa-type dough can be made by combining the corn materials, pH increasing agent, and water. The dough can be made by combining the ingredients with water in any suitable manner, such as by mixing, blending, combining, or stirring.

Any suitable amount of water can be used to make the masa-type dough herein. In one embodiment, from about 25% to about 40% of added water is added to the other ingredients to form the masa-type dough. Preferably, the amount of total water present in the masa-type dough is from about 30% to about 50%.

As used herein, “added water” refers to water which is added in any form to the dry ingredients, including any water used to dissolve or disperse ingredients. For example, if maltodextrin or corn syrup solids are added as a solution or syrup, the water in the syrup or solution is included in the “added water.” “Total water” is the total amount of water present in the masa-type dough, and includes added water as well as water that is inherently present in the dry ingredients, such as that in the case of flours and starches.

C. Food Products

The masa-type dough can be used to make any suitable food product, including those traditionally made using corn masa or corn masa flour. Such food products can include, but are not limited to, tortilla chips, tortillas, taco shells, tamales, extruded snacks, half-products, and various types of fabricated snacks such as fabricated corn-based snacks.

One preferred use of the masa-type dough is to make tortilla chips. In one embodiment, the dough is sheeted then cut into snack pieces and baked for about 15 to about 30 seconds at a temperature of from about 575° F. to about 600° F. (302° C. to 316° C.) to reduce the moisture content to from about 20% to about 35%. The baked snack pieces are then fried in hot oil to form tortilla chips having a moisture content of less than about 3%.

The masa-type dough can also be used to make tortilla chips such as those described in U.S. Pat. No. 2,905,559, issued Nov. 1, 1958 to Anderson et al., U.S. Pat. No. 3,690,895, issued Sep. 12, 1972 to Amadon et al., and Corn: Chemistry and Technology, American Association of Cereal Chemists, Stanley A. Watson, et. al., Ed., pp. 410-420 (1987).

Although less-preferred, in one embodiment, the masa-type dough is used to make dried masa flour by grinding and dehydrating. The dried masa-type flour can be later rehydrated with water to form a masa-type dough that is then used to produce tortilla chips, such as those described in U.S. Pat. No. 6,572,910, issued Jun. 3, 2003, to Lanner et al.

D. Article of Commerce

In another aspect, the present invention provides an article of commerce comprising:
1. a non-steeped corn blend, comprising:
   (a) non-steeped non-gelatinized corn material;
   (b) non-steeped pre-gelatinized corn material; and
   (c) pH increasing agent; and
2. optionally, a container for containing the non-steeped corn blend; and
3. a message associated with the non-steeped corn blend.

In another embodiment, the article of commerce comprises:
1. a non-steeped corn blend material selected from the group consisting of non-steeped non-gelatinized corn material, non-steeped pre-gelatinized corn material, a pH increasing agent, and mixtures thereof;
2. optionally, a container for containing said non-steeped corn blend material; and
3. a message associated with the non-steeped corn blend material.

The message informs the consumer that the non-steeped corn blend or non-steeped corn blend material (“material”) can be used to make a masa-type dough and/or food product. In one embodiment, the message provides instructions for use. In a particular embodiment, the message instructs the consumer to combine the non-steeped corn blend with water to form a masa-type dough. In another embodiment, the message communicates that the material can be combined with other ingredients to form a non-steeped corn blend. In yet another embodiment, the message communicates that the material can be combined with one or more other ingredients to form a masa-type dough and/or food product. In a particular embodiment, the message informs the consumer that the non-steeped corn blend or material can be used to make a masa-type dough and/or food product without performing a steeping step. In another aspect, the message includes instructions for use, wherein said instructions do not include a steeping step.

The message can be printed material attached directly or indirectly to a container that contains the non-steeped corn blend or material, attached directly or indirectly near a container, or alternatively can be a printed, electronic, or broadcast message associated with the non-steeped corn blend or material.

Any container from which the non-steeped corn blend or material can be dispensed, presented, displayed, or stored is suitable. Suitable containers include, but are not limited to, bags, canisters, boxes, drums, rail cars, tubs, and cans.

In one embodiment, the non-steeped non-gelatinized corn material and the non-steeped pre-gelatinized corn material are in the form of a combined mixture in the article of commerce. In another embodiment, the non-steeped non-gelatinized corn material and the non-steeped pre-gelatinized corn material are not combined in the article of commerce, but rather are segregated as separate materials.

In one embodiment, a pH increasing agent is included with the article of commerce. In another embodiment, a pH increasing agent is not included with the article of commerce; in this embodiment, the consumer can be instructed to use a pH increasing agent that the consumer supplies from another source.

As used herein, the term “consumer” is broad enough to include any user or purchaser of the article of commerce.

Because corn materials are commonly available ingredients, the article of commerce of the present invention can be made and used throughout geographies where corn masa is not readily available. Furthermore, non-steeped corn blends can be produced in one region of the world and shipped long distances to other parts of the world where they will ultimately be used; the present invention thus provides a means for producing masa-type food products in regions of the world where they could not otherwise easily be produced.

### ANALYTICAL METHODS

Parameters used to characterize elements of the present invention are quantified by particular analytical methods. These methods are described in detail as follows.

A. Rheological Properties Using the Rapid Visco Analyzer (RVA)

The rheological properties of the dry ingredients are measured using the Rapid Visco Analyzer (RVA) model RVA-4 supplied by Newport Scientific Pty. Ltd. of Warriewood NSW 2102 Australia. The instrument, including moisture content corrections, should be operated in accordance with the manufacturer's instructions (using Standard Profile 1).

The parameters used to characterize components of the present invention are peak viscosity, final viscosity, and peak time. The average of 3 sample peak viscosity values is considered to be the respective peak viscosity of a material, while the average of 3 sample final viscosity values is considered to be the final viscosity for a material. The average of 3 sample peak time values is considered to be the respective peak time of a material.

RVA Method For Dry Ingredients:

1. Determine the % moisture (M) of a sample as follows:
a.) Weigh the sample to the nearest 0.01 gram.
b.) Dry the sample in a convection oven at 130° C. for 3 hours.
c.) Immediately after removing the sample from the oven, weight the sample to the nearest 0.01 gram.
d.) Divide the dry weight of the sample by the initial weight of the sample and multiply the result by 100. This is the % moisture for the sample.
e.) An alternative method is to use thennogravimetric analysis (TGA) to shorten analysis time and minimize sample quantity. In TGA, the weight loss of a sample is monitored as the sample undergoes programmed heating. The samples are typically heated from ambient temperature to 150° C. at 10° C./minute. The residual weight percentage at 150° C. is subtracted from 100% to obtain the percent moisture.

2. Calculate sample weight (S) and water weight (W) of the sample using Table 1 titled Weight of Sample and Added Water Corrected for Moisture Content found on page 20 of the RVA-4 Series Instruction Manual, Issued March 1998 or the following equations, which correct for the native water content.
Amount of flour=(86%*sample size, g)/(100%-Moisture content, %)
Amount of water=25 g+(desired sample size, g-corrected sample size, g)

3. Place the sample into a canister containing an equivalent weight of distilled and deionized water as that of the water weight obtained in Step (2) above and stir the combined sample and distilled and deionized water mixture using the RVA paddle by rotating said paddle 10 times in said mixture. For flour blends, all dry ingredients are first mixed in a small food processor prior to adding water.

4. Place the canister into RVA tower and run the Standard Profile (1) which results in a graph of paste viscosity versus time.

5. From the graph of paste viscosity versus time read the maximum viscosity obtained during the heating and holding cycles of the Standard Profile (1). The maximum viscosity is the sample peak viscosity.

6. From the graph of paste viscosity versus time read the viscosity obtained at the end of the test. Said viscosity is the final viscosity.

7. The peak time is obtained from the graph of time versus viscosity. It is equivalent to the time that the peak viscosity is obtained.

B. pH of Food Ingredients

### REFERENCES

AOAC Official Methods of Analysis, 13^{th} Edition, Assoc. Off. Anal. Chem., Washington, D.C. 1980 (Sec. 33.006-33.008, 14.022, 50.007(c), 50.007(f)).

### PRINCIPLE

A glass combination pH electrode and standard pH meter are used to measure the hydrogen ion concentration of an aqueous solution. Weighed 10 g samples diluted 10:1 with distilled water or alcohol-water, are measured against standard buffer solutions. Results are reported directly from the meter readout.

### SCOPE

This method applies to seasonings, dry mixes, aqueous systems, and other materials soluble/dispersible in water.

### VALIDATION

Accuracy

Two standard buffer solutions are used to calibrate the pH meter before each group of samples are analyzed. Recheck of the calibration-must be within ±0.05 pH units.

EQUIPMENT/REAGENTS—those listed below, or their equivalents, are used.

| | |
|---|---|
| Equipment | |
| pH Meter | Beckman laboratory models, Orion, Lees & Northrup, or |
| | Corning 7 and 10. Meters from other suppliers may be |
| | used if equivalent to those listed. |
| Electrode | Corning #476051; or Orion #910500 |
| Stirrer | Mechanical, either air or electrically driven, or a magnetic |
| | stirrer whose speed can be regulated. |
| Absorbent | Kim Wipes ™ (Kimberly Clark, Irving, Texas, USA) |
| Tissue | |
| Beaker | 250 mL |
| Stir Bar | Glass |
| Spinbar | Magnetic Stirring Bar, 1 × ⅜″ |
| Reagents | |
| Buffer | Use standard buffer solutions to cover the pH range |
| Solutions | desired, such as 4, 7 and 10. Beckman buffer solutions are |
| | recommended. Each pH range gives the corrected pH |
| | value at different temperatures. |
| Distilled | Boil distilled water vigorously for 10 minutes, or longer. |
| Water | Cool rapidly while aerating with carbon dioxide-free air or |
| | nitrogen, or pass distilled water through an ion exchange |
| | column. (Illco-Way, Ion-X-Change, Research Model, |
| | Matheson #242-115, or equivalent.) |
| Absolute | 100%, Aaper ™ (Aaper Alcohol, Shelbyville, Kentucky, |
| Ethanol | USA) |
| Ethanol | Anhydrous, “Baker Analyzed” Reagent. Denatured |
| | alcohol from drums is acceptable. Use to rinse electrode. |

### OPERATION

Standardization of pH Meter

1. Place tip of electrode in pH 7.00 buffer. Buffer should be in beaker and stirring while readings are being taken. Adjust calibration knob until instrument reads 7.00.

2. Turn instrument to “stand by”. Rinse electrode with distilled water, wipe with tissue. Place electrode in pH 4.00 buffer. Use slope control to adjust instrument to read 4.00.

3. Recheck both buffer solutions, following Steps 1 and 2, before proceeding. If the readings are ±0.05, you are ready to proceed.

Operation For Samples:

1. Rinse electrodes with distilled water and wipe dry before placing electrode in buffer or sample solutions.

2. Weigh 10.0±0.1 g sample into a clean, dry 250 mL beaker.

3. Add 90 mL of neutral distilled water.

4. Agitate the contents of the beaker with a mechanical or magnetic stirrer. Stir vigorously so that a vortex is formed, but not splashing.

5. Stir until solution is well mixed, but no less than five minutes.

6. While stirring the sample, place the pH electrode in the solution. The pH value should reach equilibrium within one minute.

7. Read and record pH of the solution.

Note:

If the pH does not reach equilibrium at the end of 1 minute, it is apparent that the electrode has become sluggish and needs reconditioning. This can be accomplished by placing the electrode in a saturated solution of KCl overnight. Rinse and soak in pH 4 buffer for approximately one hour. Recalibrate. If the Corning #476051 electrode is being used, it may also be necessary to replace the KCl solution inside the electrode before reconditioning. If either of these steps does not result in stable readings of a buffer solution within one minute, the electrode should be discarded. Store electrodes in pH 4 buffer when not in use. For long term storage of electrode, cover breather hole and place protective cap on tip of electrode.

### EXAMPLES

The following examples are illustrative of the present invention but are not meant to be limiting thereof.

### Example 1

### Non-Steeped Corn Blend

A non-steeped corn blend is prepared from 30% corn meal (a non-steeped pre-gelatinized corn material) (PCPF™ 400, available from Bunge Milling, Danville, Ill., USA), 15% native corn starch (an optional ingredient) (Melojel™, available from National Starch and Chemical Company, Bridgewater, N.J., USA), 55% white corn flour (a non-steeped non-gelatinized corn material) (WCCF™ 611, available from Bunge Milling, Danville, Ill., USA), and 0.1% calcium hydroxide powder (1.0 mg of Ca(OH)₂ per gram of the combined blend) (calcium hydroxide powder, food grade, Lot 33716, available from Penta Manufacturing, Livingston, N.J., USA). All ingredients are thoroughly admixed by blending in a Cuisinart™ food processor. The peak viscosity of the blend is 2000 cP, the final viscosity is 4220 cP, and the peak time is 4.98 minutes.

### Example 2

Non-steeped corn blend formulations 2a, 2b, and 2c are set forth in the table below. In these formulas, coarse corn masa flour is included to control expansion of the chips during frying. The blend ingredients, including the calcium hydroxide, are mixed together in a Cuisinart™ food processor. Then, water is added such that the total amount of water present in the resulting masa-type dough is 32.01%. The dough is mixed in three 300 g batches in a Cuisinart food processor and sheeted together. The water at a temperature of 155° F.-160° F. (68° C.-71° C.) is added over a period of 10 seconds and the dough is mixed for 15 seconds. A portion of dough is sheeted and ground in a food processor to mimic recycled dough on the plant scale. The recycled dough is added to the remaining dough and sheeted to a thickness of about 0.033 inch (0.84 mm). Dough pieces are cut and fried at 395° F. (202° C.) in oil for 34 seconds. The moisture content of the finished chips is 4.9%. The chips are light yellow in color and have a bubbly texture. The chips have a flavor characteristic of traditional tortilla chips.

| | % | % | % |
|---|---|---|---|
| Ingredient | 2a | 2b | 2c, |
| Coarse Corn Masa, retained on | 11.28 | 11.28 | 11.28 |
| a #25 US sieve (Azteca Milling, | | | |
| Irving, Texas, USA) | | | |
| White Corn Flour (a non-steeped | 35.54 | 35.54 | 35.54 |
| non-gelatinized corn material) | | | |
| (WCCF ™ 611, Bunge Milling, | | | |
| Danville, Illinois, USA), | | | |
| Pregel Corn Meal (a non-steeped | 38.10 | 38.10 | 38.10 |
| pre-gelatinized corn material) | | | |
| (PCPF ™ 400, Bunge Milling, | | | |
| Danville, Illinois, USA), | | | |
| Calcium Hydroxide (powder, | 0.03 | 0.03 | 0.03 |
| food grade, Lot 33716, Penta | | | |
| Manufacturing, Livingston, | | | |
| New Jersey, USA) | | | |
| Sucrose | 0.52 | 0.52 | 0.52 |
| Salt (flour) | 0.5 | 0.5 | 0.5 |
| Sago Starch (National Starch | 6.09 | — | — |
| and Chemical Company, Bridgewater, | | | |
| New Jersey, USA) | | | |
| X-Pand'R ™ 612 (acid | — | 6.09 | — |
| hydrolyzed waxy corn starch) | | | |
| (A. E. Staley Mfg. Co., | | | |
| Decatur, Illinois, USA) | | | |
| Pregel Potato Starch (Paselli | — | — | 6.09 |
| EZ ™ 1005, Avebe B. A., The | | | |
| Netherlands) | | | |
| Thermtex ™ (a hydroxypropyl | 7.79 | 7.79 | 7.79 |
| distarch phosphate waxy corn | | | |
| starch) (National Starch and | | | |
| Chemical Company, Bridgewater, | | | |
| New Jersey, USA) | | | |
| Lecithin (Ultralec F ™, | 0.15 | 0.15 | 0.15 |
| ADM, Decatur, Illinois, USA) | | | |

### Example 3

### Article of Commerce

The non-steeped corn blend of Example 1 is packaged in a bag for sale to consumers. An instruction sheet accompanying the bag instructs the consumer to make a masa-type dough by mixing 68% non-steeped corn blend with 32% added water. The instruction sheet does not instruct the consumer to steep the corn blend.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A non-steeped corn blend, comprising:
a. non-steeped non-gelatinized corn material;
b. non-steeped pre-gelatinized corn material; and
c. pH-increasing agent.

2. A method for making a masa-type dough, wherein said method comprises:
a. providing the non-steeped corn blend of claim 1;
b. providing water; and
c. mixing the non-steeped corn blend and the water to form a dough;
wherein said method does not include a steeping step.

3. A masa-type dough, wherein said masa-type dough is made by a method comprising:
a. providing the non-steeped corn blend of claim 1;
b. providing water; and
c. mixing the non-steeped corn blend and the water to form a dough;
wherein said method does not include a steeping step.

4. A food product, wherein said food product is made by a method comprising:
a. providing the masa-type dough of claim 3;
b. forming a food piece from said masa-type dough; and
c. cooking said food piece to form a food product.

5. A method for making a masa-type dough, wherein said method comprises:
a. providing non-steeped non-gelatinized corn material;
b. providing non-steeped pre-gelatinized corn material;
c. providing pH increasing agent; and
d. mixing the non-steeped non-gelatinized corn material, the non-steeped pre-gelatinized corn material, and pH increasing agent to form a dough;
wherein said method does not include a steeping step.

6. A masa-type dough, wherein said masa-type dough is made according to the method of claim 5.

7. A food product, wherein said food product is made by a method comprising:
a. providing the masa-type dough of claim 6;
b. forming a food piece from said masa-type dough; and
c. cooking said food piece to form a food product.

8. A method for making a masa-type dough, wherein said method comprises:
a. providing non-steeped non-gelatinized corn material;
b. providing non-steeped pre-gelatinized corn material;
c. providing pH increasing agent;
d. providing a corn masa product, wherein said corn masa product is selected from the group consisting of corn masa, corn masa flour, and mixtures thereof; and
d. mixing the non-steeped non-gelatinized corn material, the non-steeped pre-gelatinized corn material, pH increasing agent, and corn masa product to form a dough;
wherein said method does not include a steeping step.

9. An article of commerce comprising:
a. the non-steeped corn blend of claim 1;
b. optionally, a container for containing the non-steeped corn blend; and
c. a message associated with the non-steeped corn blend.

10. The article of claim 9, wherein said message comprises instructions to make a masa-type dough, instructions to make a food product, or combinations thereof.

11. The article of claim 10, wherein said instructions do not include a steeping step.

12. An article of commerce comprising:
a. a non-steeped corn blend material selected from the group consisting of non-steeped non-gelatinized corn material, non-steeped pre-gelatinized corn material, pH increasing agent, and mixtures thereof;
b. optionally, a container for containing said non-steeped corn blend material; and
c. a message associated with the non-steeped corn blend material.

13. The article of claim 12, wherein said message comprises instructions to make a masa-type dough, instructions to make a food product, or combinations thereof.

14. The article of claim 13, wherein said instructions do not include a steeping step.
